(19) United States
(12) Patent Application Publication
(10) Pub. No.: US 2002/0191785 A1
(43) Pub. Date: Dec. 19, 2002

(54) Apparatus and method for encrypting and decrypting data with incremental data validation

(75) Inventors: Gerald Francis McBrearty, Austin, TX (US); Shawn Patrick Mullen, Buda, TX (US); Johnny Meng-Han Shieh, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/881,921

(22) Filed: Jun. 14, 2001

(51) Int. Cl. H04K 1/04

(52) U.S. Cl. 380/37

(57) ABSTRACT

An apparatus and method for encrypting and decrypting data with incremental data validation is provided. With the apparatus and method, data is encrypted and a digital digest is generated in chunks. That is, the digital digest is comprised of a plurality of intermediate digital digest chunks, each of which can be used to validate a portion of the associated encrypted data. During decryption, a portion of the encrypted data is read and decrypted at approximately the same time that a digital digest is calculated for that portion of the encrypted data. The calculated digital digest may then be compared to an intermediate digital digest associated with the portion of the encrypted data, and which is appended to the encrypted data. If the two digital digests match, decryption of the encrypted data may proceed to the next portion of the encrypted data. If the two digital digests do not match, decryption is halted and the data message or packet is discarded without having decrypted the entire data message or packet. In this way, resources may be freed from processing non-authentic data messages or packets so that they may be used in processing authentic data messages. Thus, the susceptibility of the present invention to denial of service attacks is noticeably reduced in comparison with the prior art.

### BACKGROUND OF THE INVENTION

1. Technical Field

The present invention is directed to an improved computing device. More specifically, the present invention is directed to an apparatus and method for encrypting and decrypting data with incremental data validation.

2. Description of Related Art

Internet Protocols which use cryptography are prone to Denial of Service (DOS) attacks because cryptography requires a large amount of processor time. A DOS attack is an assault on a network that floods it with so many additional requests that regular traffic is either slowed or completely interrupted. The regular traffic is slowed or completely interrupted because the victim computer systems must expend resources to decrypt the data in these numerous requests only to find that the requests are not authentic. Thus, resources that could be used to handle regular traffic is instead tied up with handling unauthentic requests sent as part of a DOS attack.

In order to avoid such attacks, messages and packets which are encrypted may have a digital digest attached to them for authentication purposes. A digital digest is a mechanism used to uniquely identify the contents of the message or packet. A digital digest may be a checksum or the like, for example.

FIG. 1 is a diagram illustrating a known mechanism for encrypting data. As shown in FIG. 1, clear text data 110 is initially received. The data is encrypted to product encrypted data 120. Encrypted data is read byte by byte to create a unique digital digest 130 for the encrypted data. The digital digest is encrypted and appended to the encrypted data to thereby produce and encrypted message or packet 140. The encrypted message or packet 140 may then be transmitted to a receiving device.

At the receiving device, in order to process the data, the message or packet 140 must first be authenticated and decrypted before the processor is able to process the encrypted data. In order to authenticate the message or packet 140, all of the encrypted data 120 in the message or packet 140 must first be read to calculate a corresponding digital digest. The digital digest 130 appended to the encrypted data 120 is then decrypted and compared to the digital digest calculated based on the encrypted data in the received data message or packet 140.

If the two digital digests, match, the data message or packet 140 is authentic. If the data message or packet 140 is authentic, then the encrypted data 120 may be decrypted and processed. Otherwise, if the data message or packet 140 is not authentic, the data message or packet 140 is discarded. Thus, with the prior art mechanisms, all of the encrypted data in the data message or packet 140 must be read twice in order to authenticate and decrypt the data message or packet 140.

Therefore, it would be beneficial to have an apparatus and method by which data messages or packets may be authenticated and decrypted using a single pass on the encrypted data. Moreover, it would be beneficial to have an apparatus and method for incrementally authenticating a data message or packet based on a digital digest so that processing of non-authentic data messages or packets is halted at an earliest possible time to thereby free resources that may be used in authenticating and decrypting authentic data messages or packets.

### SUMMARY OF THE INVENTION

The present invention provides an apparatus and method for encrypting and decrypting data with incremental data validation. With the mechanism of the present invention, data is encrypted and a digital digest is generated in chunks. That is, the digital digest is comprised of a plurality of intermediate digital digest chunks, each of which can be used to validate a portion of the associated encrypted data. During decryption, a portion of the encrypted data is read and decrypted at approximately the same time that a digital digest is calculated for that portion of the encrypted data.

The calculated partial digital digest may then be compared to an intermediate digital digest associated with the portion of the encrypted data, and which is appended to the encrypted data. If the two digital digests match, decryption of the encrypted data may proceed to the next portion of the encrypted data. If the two digital digests do not match, decryption is halted and the data message or packet is discarded without having decrypted the entire data message or packet.

In this way, resources may be freed from processing non-authentic data messages or packets so that they may be used in processing authentic data messages. Thus, the susceptibility of the present invention to denial of service attacks is noticeably reduced in comparison with the prior art.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram of a prior art method of encrypting/decrypting data using a digital digest;

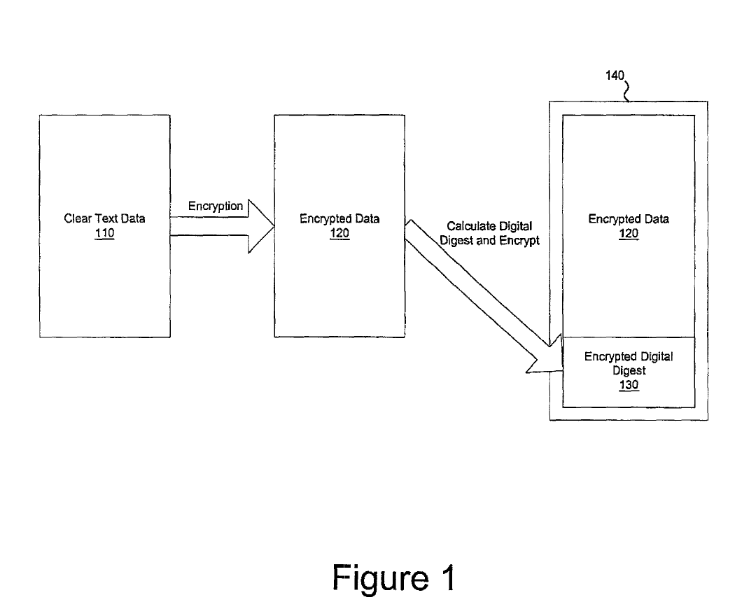

FIG. 2 is an exemplary diagram illustrating a distributed data processing system in accordance with the present invention;

FIG. 3 is an exemplary diagram illustrating a server data processing device in accordance with the present invention;

FIG. 4 is an exemplary diagram illustrating a client data processing device in accordance with the present invention;

FIG. 5 is a diagram illustrating an encryption operation according to the present invention;

FIG. 6 is a diagram illustrating a decryption operation according to the present invention;

FIG. 7 is a flowchart outlining an exemplary operation for encrypting data according to the present invention; and

FIG. 8 is a flowchart outlining an exemplary operation for decrypting data according to the present invention.

### DETAILED DESCRIPTION OF THE PREFERRED EMBODIMENT

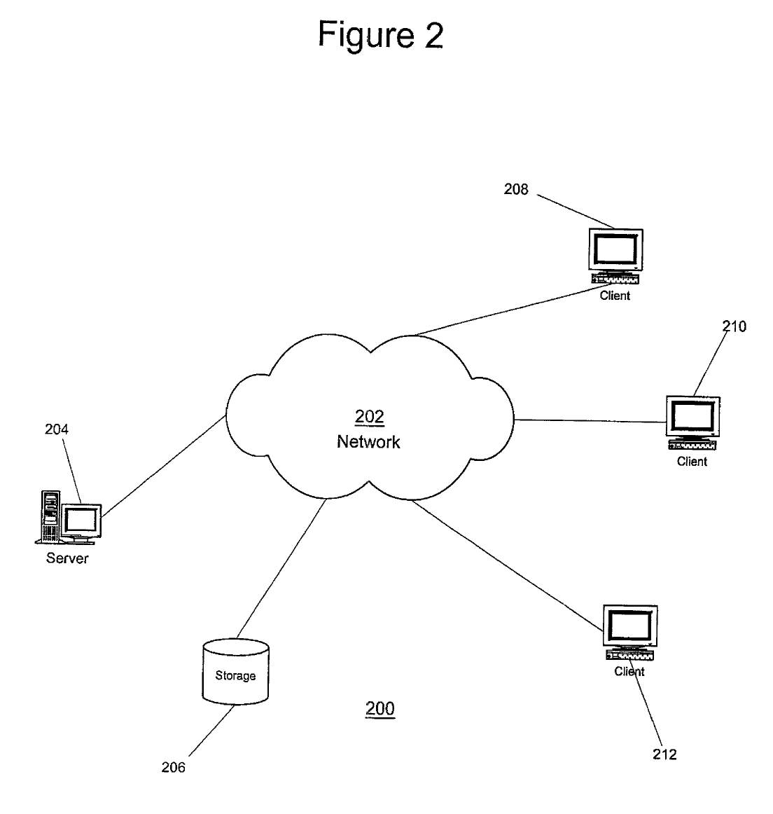

With reference now to the figures, FIG. 2 depicts a pictorial representation of a network of data processing systems in which the present invention may be implemented. Network data processing system 200 is a network of computers in which the present invention may be implemented. Network data processing system 200 contains a network 202, which is the medium used to provide communications links between various devices and computers connected together within network data processing system 200. Network 202 may include connections, such as wire, wireless communication links, or fiber optic cables.

In the depicted example, server 204 is connected to network 202 along with storage unit 206. In addition, clients 208, 210, and 212 are connected to network 202. These clients 208, 210, and 212 may be, for example, personal computers or network computers. In the depicted example, server 204 provides data, such as boot files, operating system images, and applications to clients 208-212. Clients 208, 210, and 212 are clients to server 204. Network data processing system 200 may include additional servers, clients, and other devices not shown.

In the depicted example, network data processing system 200 is the Internet with network 202 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 200 also may be implemented as a number of different types of networks, such as for example, an intranet, a local area network (LAN), or a wide area network (WAN). FIG. 2 is intended as an example, and not as an architectural limitation for the present invention.

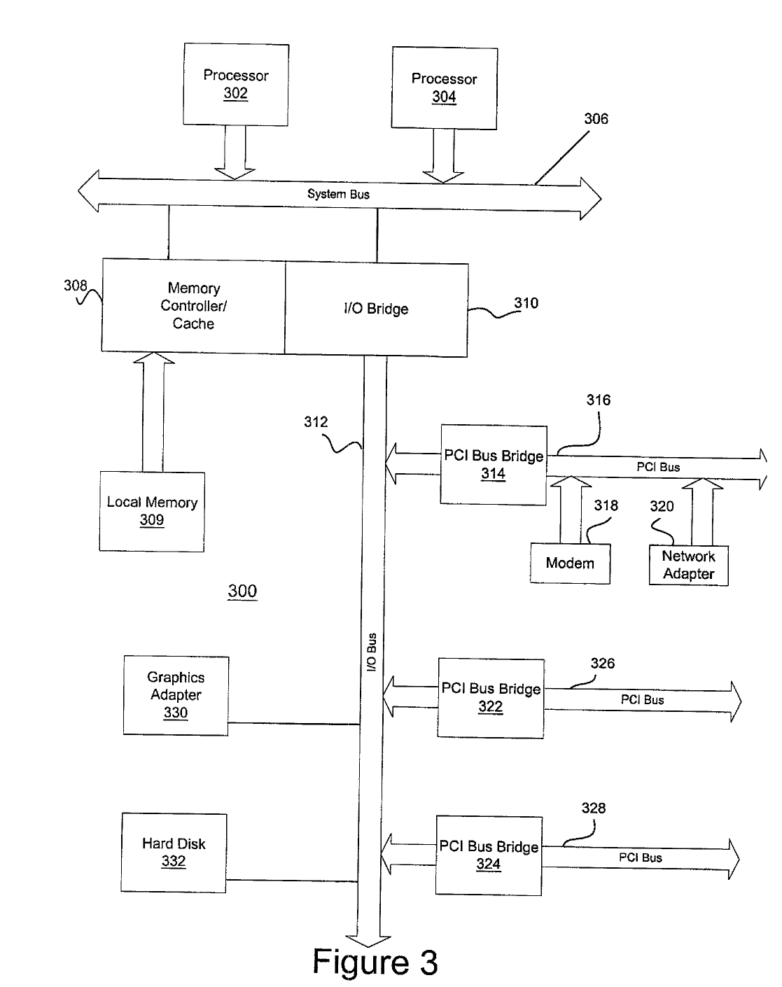

Referring to FIG. 3, a block diagram of a data processing system that may be implemented as a server, such as server 204 in FIG. 2, is depicted in accordance with a preferred embodiment of the present invention. Data processing system 300 may be a symmetric multiprocessor (SMP) system including a plurality of processors 302 and 304 connected to system bus 306. Alternatively, a single processor system may be employed. Also connected to system bus 306 is memory controller/cache 308, which provides an interface to local memory 309. I/O bus bridge 310 is connected to system bus 306 and provides an interface to I/O bus 312. Memory controller/cache 308 and I/O bus bridge 310 may be integrated as depicted.

Peripheral component interconnect (PCI) bus bridge 314 connected to I/O bus 312 provides an interface to PCI local bus 316. A number of modems may be connected to PCI local bus 316. Typical PCI bus implementations will support four PCI expansion slots or add-in connectors. Communications links to network computers 208-212 in FIG. 2 may be provided through modem 318 and network adapter 320 connected to PCI local bus 316 through add-in boards.

Additional PCI bus bridges 322 and 324 provide interfaces for additional PCI local buses 326 and 328, from which additional modems or network adapters may be supported. In this manner, data processing system 300 allows connections to multiple network computers. A memory-mapped graphics adapter 330 and hard disk 332 may also be connected to I/O bus 312 as depicted, either directly or indirectly.

Those of ordinary skill in the art will appreciate that the hardware depicted in FIG. 3 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 3 may be, for example, an IBM e-Server pSeries system, a product of International Business Machines Corporation in Armonk, N.Y., running the Advanced Interactive Executive (AIX) operating system or LINUX operating system.

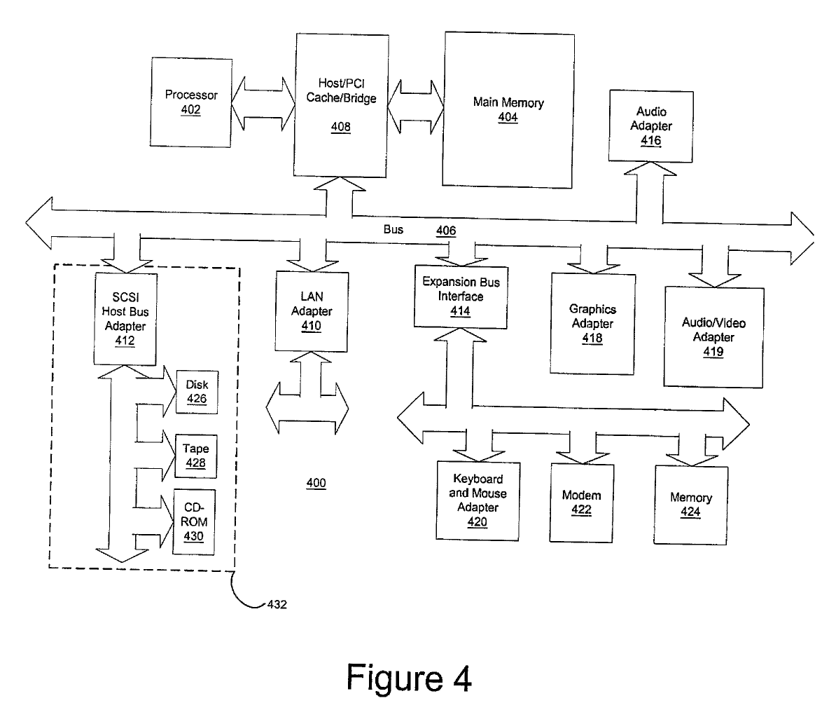

With reference now to FIG. 4, a block diagram illustrating a data processing system is depicted in which the present invention may be implemented. Data processing system 400 is an example of a client computer. Data processing system 400 employs a peripheral component interconnect (PCI) local bus architecture. Although the depicted example employs a PCI bus, other bus architectures such as Accelerated Graphics Port (AGP) and Industry Standard Architecture (ISA) may be used. Processor 402 and main memory 404 are connected to PCI local bus 406 through PCI bridge 408. PCT bridge 408 also may include an integrated memory controller and cache memory for processor 402. Additional connections to PCI local bus 406 may be made through direct component interconnection or through add-in boards. In the depicted example, local area network (LAN) adapter 410, SCSI host bus adapter 412, and expansion bus interface 414 are connected to PCI local bus 406 by direct component connection. In contrast, audio adapter 416, graphics adapter 418, and audio/video adapter 419 are connected to PCI local bus 406 by add-in boards inserted into expansion slots. Expansion bus interface 414 provides a connection for a keyboard and mouse adapter 420, modem 422, and additional memory 424. Small computer system interface (SCSI) host bus adapter 412 provides a connection for hard disk drive 426, tape drive 428, and CD-ROM drive 430. Typical PCI local bus implementations will support three or four PCI expansion slots or add-in connectors.

An operating system runs on processor 402 and is used to coordinate and provide control of various components within data processing system 400 in FIG. 4. The operating system may be a commercially available operating system, such as Windows 2000, which is available from Microsoft Corporation. An object oriented programming system such as Java may run in conjunction with the operating system and provide calls to the operating system from Java programs or applications executing on data processing system 400. “Java” is a trademark of Sun Microsystems, Inc. Instructions for the operating system, the object-oriented operating system, and applications or programs are located on storage devices, such as hard disk drive 426, and may be loaded into main memory 404 for execution by processor 402.

Those of ordinary skill in the art will appreciate that the hardware in FIG. 4 may vary depending on the implementation. Other internal hardware or peripheral devices, such as flash ROM (or equivalent nonvolatile memory) or optical disk drives and the like, may be used in addition to or in place of the hardware depicted in FIG. 4. Also, the processes of the present invention may be applied to a multiprocessor data processing system. As another example, data processing system 400 may be a stand-alone system configured to be bootable without relying on some type of network communication interface, whether or not data processing system 400 comprises some type of network communication interface. As a further example, data processing system 400 may be a Personal Digital Assistant (PDA) device, which is configured with ROM and/or flash ROM in order to provide nonvolatile memory for storing operating system files and/or user-generated data.

The depicted example in FIG. 4 and above-described examples are not meant to imply architectural limitations. For example, data processing system 400 also may be a notebook computer or hand held computer in addition to taking the form of a PDA. Data processing system 400 also may be a kiosk or a Web appliance.

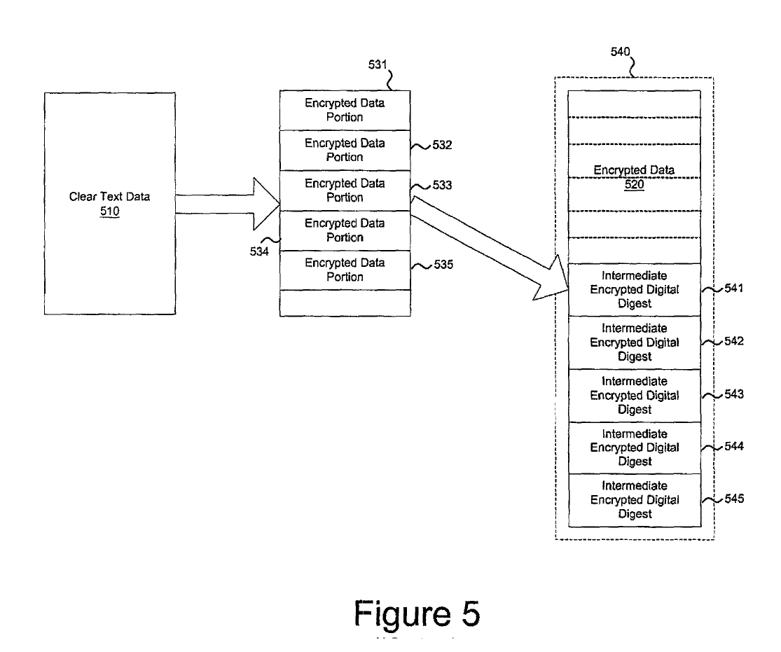

FIG. 5 is an exemplary diagram illustrating a data encryption operation according to the present invention. The operation shown in FIG. 5 may be implemented as hardware, software, or a combination of hardware and software. For example, in a preferred embodiment, the present invention is implemented as software instructions executed by a processor on data stored in a memory, storage device, or buffer. For example, the present invention may be implemented as computer program instructions executed by one or more of the processors 302, 304 and 402 on data stored in a memory, storage device or buffer, such as local memory 309, hard disk 332, main memory 404, disk 426, tape 428, CD-ROM 430, memory 424, or the like. Alternatively, the present invention may be implemented using data obtained via a communications interface such as modem 318, network adapter 320, LAN adapter 410, or modem 422. Other embodiments of the present invention may obtain data for use with the present invention via other mechanisms without departing from the spirit and scope of the present invention.

As shown in FIG. 5, clear data 510 is read in chunks and encrypted as a plurality of encrypted data portions 531-535. The encrypted data portions 531-535 correspond to chunks of data and may be of any desirable size. In an exemplary embodiment, the encrypted data portions 531-535 correspond to 64 byte data chunks of the clear data 510. In an exemplary embodiment, the data is read and stored in a buffer (not shown) which then outputs the data to a processor in chunks of a predetermined size. As the chunks of data are output from the buffer, the present invention is implemented on the data chunks.

For each of the encrypted data portions 531-535, a digital digest is generated. The generation of a digital digest from encrypted data is generally known in the art and thus, a detailed explanation of the procedures for generating a digital digest will not be provided herein. The digital digests of the present invention, however, differ from known digital digest generation mechanism in that a digital digest is generated for one or more intermediate portions of the encrypted data. In this way, a plurality of intermediate digital digests are generated.

Each of the plurality of intermediate digital digests are encrypted to thereby generate intermediate encrypted digital digests 541-545 which are appended to the end of the encrypted data message or packet 540. Thus, the data message or packet 540 is comprised of a plurality of encrypted data portions 531-535 and corresponding intermediate encrypted digital digests 541-545.

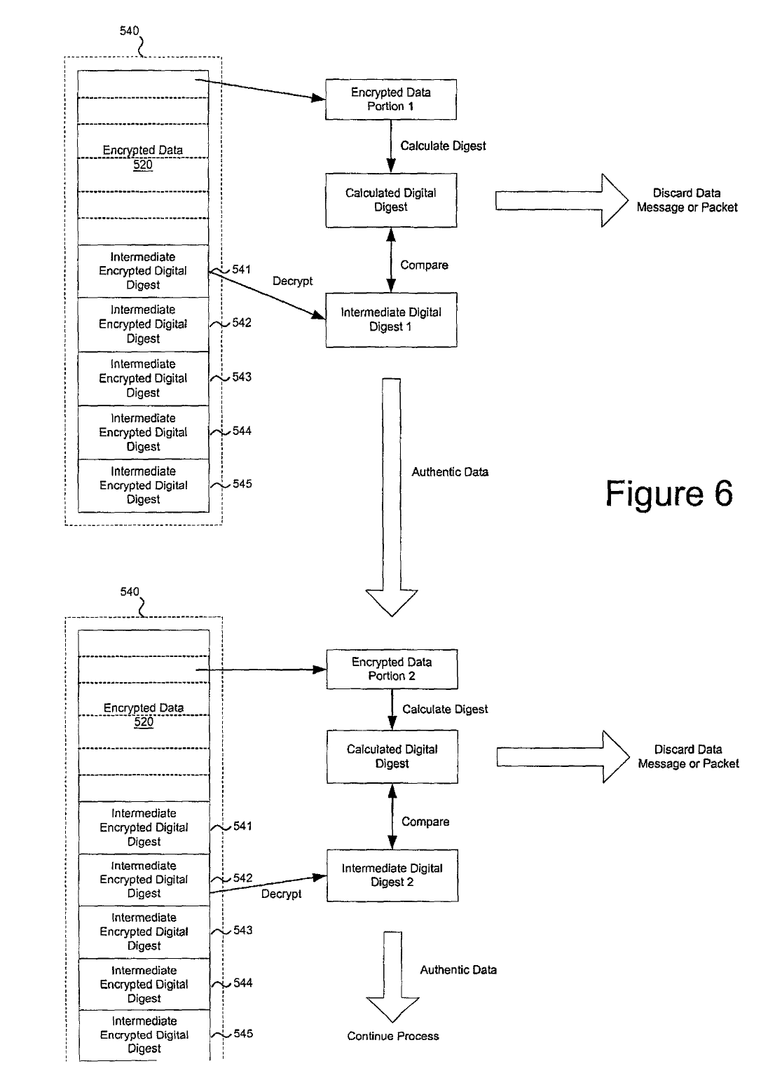

FIG. 6 is an exemplary diagram illustrating an operation for reading, authenticating, and decrypting the encrypted data message or packet 540 according to the present invention. As with the operation shown in FIG. 5, the operation shown in FIG. 15 may be implemented as software, hardware or a combination of software and hardware, depending on the particular embodiment.

As shown in FIG. 6, the operation first reads a first encrypted data portion 610 and calculates a digital digest 620 from the first encrypted data portion 610. The operation then reads and decrypts an intermediate encrypted digital digest 541, from the end of the data message or packet 540, that corresponds to the first encrypted data portion 610. The decrypted intermediate digital digest 630 is then compared to the calculated digital digest 620. If the two digital digests do not match, the data is not authentic or is otherwise corrupted and the data message or packet 540 is discarded.

If the two digital digests do match, the encrypted data portion 610 is decrypted and the next encrypted data portion 640 is read from the data message or packet 540. The process then continues in the same manner. At any time during the process, if any one of the digital digest comparisons results in a non-match, the data message or packet 540 is discarded.

Thus, the present invention provides a mechanism in which only a single pass through the encrypted data is necessary to both authenticate and decrypt the data. The present invention uses an incremental approach to authenticate portions of the encrypted data and decrypt the data. If any one of the authentication procedures results in an indication that the data may be unauthentic or corrupted, the entire data message or packet is discarded. In this way, unauthentic or corrupted data is identified at an earliest possible time during the authentication and decryption process. Therefore, resources are freed at an earlier time so that they may be used to authenticate and decrypt authentic and/or uncorrupted data.

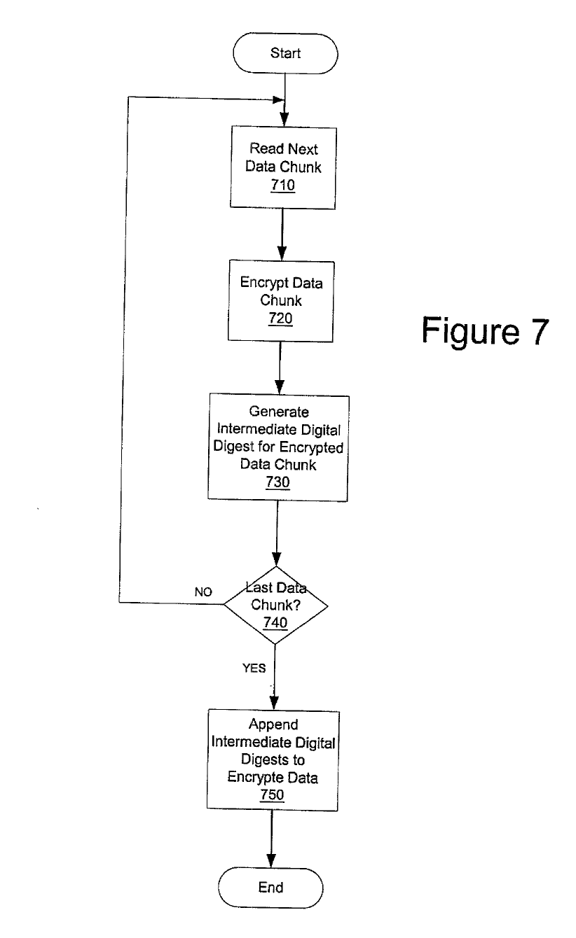

FIG. 7 is a flowchart outlining an exemplary operation of the present invention when encrypting a data message or packet. As shown in FIG. 7, the operation starts with reading the next data chunk of the data message or packet (step 710). If this is the first time through the operation, the next data chunk is the first data chunk in the data message or packet. The data chunk is then encrypted (step 720) and an intermediate digital digest is generated for the encrypted data chunk (step 730). This intermediate digital digest is preferably stored in memory until all data chunks of the data message or packet are encrypted and the data message or packet is ready for transmission.

A determination is then made as to whether the data chunk is the last data chunk in the data message or packet (step 740). If the data chunk is not the last data chunk in the data message or packet, the operation returns to step 710 and performs steps 710-730 on the next data chunk in the data message or packet. If the data chunk is the last data chunk in the data message or packet, the intermediate digital digests are appended to the encrypted data (step 750) and the operation ends. The data message or packet is then ready for storage or transmission.

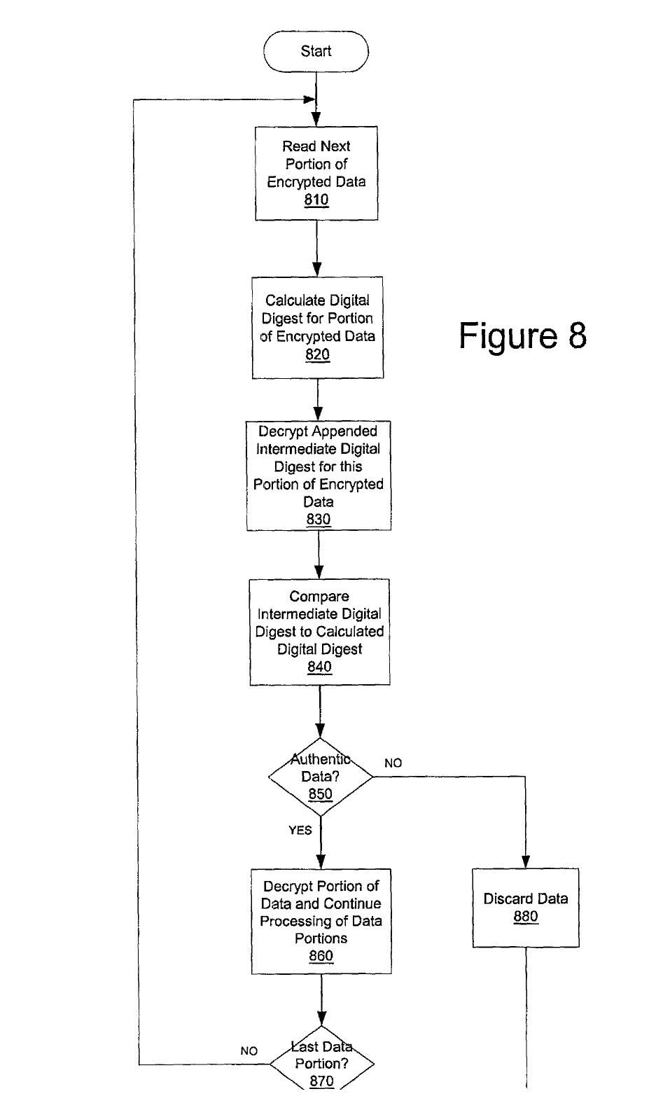

FIG. 8 is a flowchart outlining an exemplary operation of the present invention when decrypting a data message or packet. As shown in FIG. 8, the operation starts with reading the next portion of the encrypted data in the data message or packet (step 810). If this is the first time the operation is executed, the next portion of the encrypted data is a first portion of the encrypted data.

A digital digest is then calculated for the portion of the encrypted data (step 820). An appended intermediate digital digest corresponding to the portion of encrypted data is then decrypted (step 830) and compared to the calculated digital digest (step 840). A determination is then made as to whether the data is authentic based on the comparison (step 850).

If the data is not authentic, the entire data message or packet is discarded (step 880). If the data is authentic, the portion of encrypted data is decrypted and processing of the data message or packet is continued with the next portion of encrypted data in the data message or packet (step 860). A determination is made as to whether the portion is the last data portion in the data message or packet (step 870). If not, the operation returns to step 810. Otherwise, if the data portion is the last data portion in the data message or packet, the operation terminates.

While the above embodiments of the present invention have been described in terms of a one-to-one correspondence between data chunks and intermediate digital digests, such a convention is used only for simplicity of illustration of the present invention. The present invention is not limited to such embodiments. Rather, the size of the data chunks and the size of data used to generate the digital digests may be different without departing from the spirit and scope of the present invention.

Furthermore, while the above embodiments have been described in terms of intermediate digital digests that correspond to separate portions of encrypted data in the data message or packet, the present invention is not limited to such embodiments. Rather, as an alternative embodiment, the portions of encrypted data may be built up in increments of chunks of data and the corresponding digital digests may likewise be built up. In other words, assume a data message is comprised of a first, second and third data chunk. The first portion of encrypted data would correspond to an encrypted first data chunk. The second portion of the encrypted data would correspond to an encrypted combination of the first and second data chunks. The third portion of the encrypted data would correspond to an encrypted combination of the first, second and third data chunks.

As a result, the intermediate digital digests would include a first intermediate digital digest calculated from the encrypted first data chunk. The second intermediate digital digest would be calculated from a combination of the encrypted first data chunk and an encrypted second data chunk. The third intermediate digital digest would be calculated from a combination of then encrypted first, second and third data chunks. Other mechanisms for setting forth the data portions and the intermediate digital digests may be used without departing from the spirit and scope of the present invention.

Thus, the present invention provides a mechanism in which a data message or packet may be authenticated and decrypted with a single pass on the encrypted data. The present invention avoids the problems of the prior art by reducing the amount of operations necessary to perform authentication and decryption. Since the present invention is capable of identifying unauthentic data or corrupted data prior to decrypting the entire data message or packet, the present invention is less susceptible to denial of service attacks.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of encrypting data, the data being comprised of a plurality of data chunks, comprising:
encrypting each of the plurality of data chunks;
calculating a plurality of intermediate digital digests based on the encrypted data chunks, each intermediate digital digest being associated with one or more of the data chunks; and
formulating a data package comprising the encrypted data chunks and the plurality of intermediate digital digests.

2. The method of claim 1, wherein each of the intermediate digital digests corresponds to a more than one data chunk.

3. The method of claim 1, wherein each intermediate digital digest builds from a previously calculated intermediate digital digest.

4. A method of decrypting an encrypted data package, the encrypted data package being comprised of a plurality of encrypted data portions, comprising:
reading an encrypted data portion from the plurality of encrypted data portions;
calculating a calculated digital digest for the encrypted data portion;
decrypting an intermediate digital digest from the encrypted data package; and
authenticating the encrypted data portion based on a comparison of the intermediate digital digest to the calculated digital digest.

5. The method of claim 4, wherein if the intermediate digital digest matches the calculated digital digest, the encrypted data portion is authentic.

6. The method of claim 5, wherein if the encrypted data portion is authentic, the method further comprises:
decrypting the encrypted data portion; and
repeating the steps of reading, decrypting and authenticating for a next encrypted data portion of the data package.

7. The method of claim 4, wherein the intermediate digital digest corresponds to an amount of data different from an amount of data in the encrypted data portion.

8. The method of claim 4, wherein decrypting an intermediate digital digest from the encrypted data package includes reading an intermediate digital digest from a digital digest portion of the encrypted data package, the digital digest portion having a plurality of intermediate digital digests arranged in an order.

9. The method of claim 8, wherein the intermediate digital digest is built up from a previous intermediate digital digest in the order.

10. The method of claim 8, wherein the intermediate digital digest corresponds to a different amount of encrypted data than other intermediate digital digests in the digital digest portion.

11. An apparatus for encrypting data, the data being comprised of a plurality of data chunks, comprising:
means for encrypting each of the plurality of data chunks;
means for calculating a plurality of intermediate digital digests based on the encrypted data chunks, each intermediate digital digest being associated with one or more of the data chunks; and
means for formulating a data package comprising the encrypted data chunks and the plurality of intermediate digital digests.

12. The apparatus of claim 11, wherein each of the intermediate digital digests corresponds to a more than one data chunk.

13. The apparatus of claim 11, wherein each intermediate digital digest builds from a previously calculated intermediate digital digest.

14. An apparatus of decrypting an encrypted data package, the encrypted data package being comprised of a plurality of encrypted data portions, comprising:
means for reading an encrypted data portion from the plurality of encrypted data portions;
means for calculating a calculated digital digest for the encrypted data portion;
means for decrypting an intermediate digital digest from the encrypted data package; and
means for authenticating the encrypted data portion based on a comparison of the intermediate digital digest to the calculated digital digest.

15. The apparatus of claim 14, wherein if the intermediate digital digest matches the calculated digital digest, the encrypted data portion is authentic.

16. The apparatus of claim 15, further comprising:
means for decrypting the encrypted data portion; and
means for invoking the means for reading, means for decrypting and means for authenticating for a next encrypted data portion of the data package, wherein the means for decrypting the encrypted data portion and the means for invoking operate if the encrypted data portion is authentic.

17. The apparatus of claim 14, wherein the intermediate digital digest corresponds to an amount of data different from an amount of data in the encrypted data portion.

18. The apparatus of claim 14, wherein the means for decrypting an intermediate digital digest from the encrypted data package includes means for reading an intermediate digital digest from a digital digest portion of the encrypted data package, the digital digest portion having a plurality of intermediate digital digests arranged in an order.

19. The apparatus of claim 18, wherein the intermediate digital digest is built up from a previous intermediate digital digest in the order.

20. The apparatus of claim 18, wherein the intermediate digital digest corresponds to a different amount of encrypted data than other intermediate digital digests in the digital digest portion.

21. A computer program product of encrypting data, the data being comprised of a plurality of data chunks, comprising:
first instructions for encrypting each of the plurality of data chunks;
second instructions for calculating a plurality of intermediate digital digests based on the encrypted data chunks, each intermediate digital digest being associated with one or more of the data chunks; and
third instructions for formulating a data package comprising the encrypted data chunks and the plurality of intermediate digital digests.

22. The computer program product of claim 21, wherein each of the intermediate digital digests corresponds to a more than one data chunk.

23. The computer program product of claim 21, wherein each intermediate digital digest builds from a previously calculated intermediate digital digest.

24. A computer program product, of decrypting an encrypted data package, the encrypted data package being comprised of a plurality of encrypted data portions, comprising:
first instructions for reading an encrypted data portion from the plurality of encrypted data portions;
second instructions for calculating a calculated digital digest for the encrypted data portion;
third instructions for decrypting an intermediate digital digest from the encrypted data package; and
fourth instructions for authenticating the encrypted data portion based on a comparison of the intermediate digital digest to the calculated digital digest.

25. The computer program product of claim 24, wherein if the intermediate digital digest matches the calculated digital digest, the encrypted data portion is authentic.

26. The computer program product of claim 25, further comprising:
fifth instructions for decrypting the encrypted data portion; and
Sixth instructions for repeating execution of the first, second, third and fourth instructions for a next encrypted data portion of the data package, if the encrypted data portion is authentic.

27. The computer program product of claim 24, wherein the intermediate digital digest corresponds to an amount of data different from an amount of data in the encrypted data portion.

28. The computer program product of claim 24, wherein the third instructions for decrypting an intermediate digital digest from the encrypted data package include instructions for reading an intermediate digital digest from a digital digest portion of the encrypted data package, the digital digest portion having a plurality of intermediate digital digests arranged in an order.

29. The computer program product of claim 28, wherein the intermediate digital digest is built up from a previous intermediate digital digest in the order.

30. The computer program product of claim 28, wherein the intermediate digital digest corresponds to a different amount of encrypted data than other intermediate digital digests in the digital digest portion.
